(19) United States
(12) Patent Application Publication
(10) Pub. No.: US 2011/0220003 A1
(43) Pub. Date: Sep. 15, 2011

(54) Ship or floating support equipped with a device for attenuating movements of liquid contents

(76) Inventors: Christophe Colmard, Guyancourt (FR); Bruno Deletre, Versailles (FR); Christophe Huon De Kermadec, Versailles (FR); Xavier Rocher, Chatou (FR)

(21) Appl. No.: 13/129,319

(22) PCT Filed: Oct. 28, 2009
(86) PCT No.: PCT/FR2009/005283

§ 371 Date: May 13, 2011

(30) Foreign Application Priority Data
Nov. 17, 2008 (FR) 0857770

(51) Int. Cl. B63B 25/08; F17C 3/02

(52) U.S. Cl. 114/74 R

(57) ABSTRACT

A ship or floating support for carrying or storing liquid consisting of a liquefied gas, preferably chosen from methane, ethylene, propane, and butane, cooled in a large tank that is preferably cylindrical and of polygonal cross-section, that is thermally insulated, and of large size with at least its smallest dimension in the horizontal direction, in particular its width, being greater than 20 m and preferably in the range 25 m to 50 m, and presenting a volume greater than 10,000 m³ the reservoir is equipped with at least one attenuation device for attenuating movements of the liquid and having a mechanism for moving the liquefied gas liquid inside the reservoir so as to form a horizontal stream immediately below the free surface of the liquefied gas at least locally over a depth of at least 0.5 m, and preferably at least 2 m.

The present invention relates to a device for attenuating movements of the liquid contents of reservoirs of bulk carrier or bulk storage ships.

The invention relates more particularly to cryogenic carrier ships for carrying liquefied natural gas (LNG) or liquid methane, or for carrying other gases maintained in the liquid state at very low temperatures, such as propane, butane, ethylene, or any other gas of density less than the density of water in the liquefied state, carried in very large quantities in the liquid state and substantially at atmospheric pressure.

Liquefied gases carried at pressures close to atmospheric pressure need to be cooled to low temperatures in order to remain in the liquid state. They are then stored in very large reservoirs that are either spherical or cylindrical, and preferably of polygonal cross-section, and in particular that are substantially rectangular block shaped, such tanks being thoroughly thermally insulated so as to limit evaporation of the gas and so as to keep the steel of the structure of the ship at an acceptable temperature. The ships generally sail either fully laden (85% to 95% full), or with a small amount of gas remaining at the bottom of each tank (3% to 10% remaining) so as to keep the reservoirs and the insulating systems cold continuously so that the tanks can be loaded more rapidly, thereby avoiding the need for progressive cooling that is slow and time-consuming in terms of operating time.

At sea, the contents of the tanks are subjected to breaking wave effects called sloshing which can appear and become very violent inside the tank, in particular when the contents slosh against the vertical walls of the tank, and in particular also when they slosh against the trihedral corner formed by the junction between two vertical walls and the ceiling or the floor of said tank. Such sloshing is particularly sensitive to the fact that such liquids have viscosities less than the viscosity of water.

Such sloshing can also appear in anchored methane tanker ships or in anchored storage ships known as “Floating Production, Storage & Offloading” (FPSO) units when in choppy or even near-calm sea conditions, when the liquefied gas cargo starts to resonate with the excitation generated by even a small amount of swell to which the ship is subjected. When the cargo starts resonating, the sloshing can become extremely violent and when the cargo sloshes against the vertical walls or the corners it can thus damage the confinement system for confining the liquefied gas, or the insulation system present immediately behind the confinement system.

Such sloshing can appear under relatively calm sea conditions, but it generally appears only at very specific filling levels, each sea state (significant swell height/period/angle of incidence/ballasting of the ship/etc.) becoming potentially dangerous with a particular tank filling depth.

The principle of protecting harbor installations or the shore with air bubble curtains is known, such curtains significantly attenuating incident swell. Studies into bubble curtains date back a long time, and much has been published on the subject, in particular in the publication entitled “La houle et son action sur les côtes et les ouvrages côtiers” [“Swell and its action on coasts and on coastal engineering structures”] by the Russian author P. K. Bojitch.

Thus, an object of the present invention is to attenuate, or indeed to prevent, appearance of sloshing in tanks of ships for carrying or storing liquefied gas, in particular liquid methane or LNG. In the description below, the term “LNG” is used to define methane in the liquid state, i.e. liquefied natural gas, while the gaseous state is referred to as “methane” or “gaseous methane”.

To this end, the present invention provides a ship or floating support for carrying or storing liquid and including a large tank, said liquid consisting of a liquefied gas, preferably chosen from methane, ethylene, propane, and butane, cooled in said large tank, said large tank having its length disposed in the longitudinal direction XX′ of the ship and being preferably cylindrical and of cross-section that is at least in part polygonal and of axis in the longitudinal direction XX′ of the ship, said large tank being thermally insulated and of large size with at least its smallest dimension in the horizontal direction, in particular its width, being greater than 20 meters (m) and preferably in the range 25 m to 50 m, and presenting a volume greater than 10,000 cubic meters (m³), said ship or floating support being characterized in that said reservoir is equipped with at least one attenuation device for attenuating sloshing movements of said liquid and comprising movement means for moving said liquefied gas liquid inside said reservoir so as to form a horizontal stream immediately below the free surface of said liquefied gas at least locally over a depth of at least 0.5 m, and preferably at least 2 m.

In a particular embodiment, said movement means for moving said liquefied gas liquid inside said reservoir generate a movement of said liquefied gas in a direction that is not parallel to said longitudinal axial direction of the tank, and preferably in a transverse direction YY′ that is perpendicular to said longitudinal axial direction XX′ of the tank.

It can be understood that, with said liquefied gas being directed in this way, its movement makes it possible to form a said horizontal stream below the free surface of said liquefied gas in a direction that is not parallel to the longitudinal axial direction of the tank, preferably respectively in a horizontal transverse direction perpendicular to the axial longitudinal direction of the tank.

In a variant embodiment explained below, the movement means for moving the liquefied gas generate a movement of liquefied gas in a diagonal direction from one of the corners of said tank and oriented towards a vertical axis half-way along the longitudinal axis of said tank.

Said movement means for moving said liquid so as to form a horizontal stream immediately below the surface may comprise:

direct movement means acting by pumping and ejecting said liquefied gas in the liquid state and under pressure into said tank, or by motor-driven propeller propulsion of said liquefied gas in the liquid state into said tank; and/or

indirect movement means acting by reacting to generation of a gaseous stream in the liquid of said tank, namely gaseous fluid injection means for injecting gaseous fluid into said liquefied gas, or gaseous stream generation means for generating a gaseous stream of gas corresponding to said liquefied gas by heating and evaporating said liquid gas, in particular by heating a resistor by Joule effect or by heating by means of a heat carrier fluid flowing in a pipe.

It can be understood that the liquid is moved in the reservoir or the fluid is injected into the liquid of the reservoir at flow rates and pressures sufficient to form a said horizontal stream.

In both cases, a horizontal stream of said liquid just below the surface can be generated in the following two different manners:

using ejection nozzles disposed immediately below the surface and oriented so that the liquid or gaseous fluid is ejected directly in the horizontal direction; or

using ejection nozzles disposed at distances further away from the surface, but oriented so that the liquid or gaseous fluid is directed upwards towards the surface, preferably in the vertical direction. In which case, when the upward stream of liquid or gaseous fluid meets the surface, it is deflected laterally and thus horizontally at least over a certain distance possibly before moving down again in a downward stream. If the initial upward stream is situated at a certain distance from the vertical side walls of the reservoir, and preferably about midway between the two side walls, it can split into two streams in two horizontal and opposite directions, i.e. on either side of the upward stream. Conversely, if the upward flow is generated in the vicinity of the vertical wall it is deflected below the surface in a single direction towards the central zone of said tank.

A said horizontal stream is formed at least locally, i.e. over the entire length of the tank, e.g. in a transverse direction perpendicular to vertical longitudinal side walls of the tank and/or at the corners only, the various streams being oriented towards a vertical axis half-way along the length of the tank, along its middle longitudinal axis XX′.

More particularly, said movement means for moving said liquid are fluid ejection means for ejecting fluid, said fluid in liquid or in gaseous form being chosen from a liquid fluid consisting of said liquefied gas, and preferably LNG, or a gaseous fluid comprising an inert gas and preferably nitrogen, or a gas corresponding to the gas of said liquefied gas contained in said tank but in the gaseous state, or a mixture of said inert gas and of said gas in the gaseous state corresponding to the gas of said liquefied gas.

It can be understood that the liquid ejection takes place by sucking in said liquid and by delivering it under pressure into said tank by means of a pump. In an embodiment, the nozzles are mounted directly on the pumps immersed in said tank. In another embodiment, a pump outside the tank is implemented and said pump feeds a plurality of nozzles immersed in said tank.

The present invention consists in generating a movement of fluid inside the tank, the moving fluid thus constituting a calming fluid reducing resonance phenomena inside the tank or preventing them from appearing.

The stream of calming fluid can either be horizontal or, preferably, vertical, and then horizontal when said stream reaches the free surface of the liquefied gas inside the tank.

In a preferred embodiment, a vertical gaseous stream is generated inside said tank below the free surface of said liquefied gas, and preferably from the bottom of the tank and in the vicinities of the side walls of the tank.

This embodiment is preferred because firstly it is simplest to implement, and secondly the gas bubbles injected into the liquefied gas make the two-phase liquid/gas mixture compressible, whereas LNG is itself almost incompressible. Thus, the compressibility imparted to the two-phase mixture enables it to damp or indeed to eliminate the majority of the harmful effects of resonant sloshing, which effects are greatest in the vicinity of the side walls and more particularly in the corners.

More particularly, said ejection means for ejecting liquid or gaseous fluid comprise at least one pump outside said tank, and at least one manifold provided with a row of nozzles and consisting of a fluid feed pipe for feeding said fluid and disposed horizontally beneath the surface of the liquid inside said tank, and preferably at least one said feed pipe disposed in the vicinity of the bottom wall, said fluid feed pipe being provided with a plurality of ejection nozzles for ejecting said fluid upwards towards the surface in the vertical direction, the various successive nozzles of the same feed pipe preferably being spaced apart from one another by at least 0.5 m, and more preferably by in the range 1 m to 5 m.

A calming fluid is thus generated by a curtain of gas bubbles rising inside the tank.

Preferably, a horizontal stream is generated at least in the direction perpendicular to the side walls of the tank. To this end, more particularly, said fluid feed pipe(s) is/are disposed in the transverse direction YY′ or preferably in the longitudinal direction XX′ of said tank. A curtain of gas bubbles is thus generated that is parallel to the side walls of the tank, i.e. parallel to the two opposite transverse side walls or respectively to the two opposite longitudinal side walls of the tank.

Preferably, said fluid feed pipes are disposed in the longitudinal direction.

Respective feed pipes disposed in a transverse direction YY′ in the vicinities of the transverse side walls of the tank, i.e. the walls at the longitudinal ends of the tank, may be advantageous in the vicinities of the corners of the tank in order to attenuate the sloshing movements of liquid that are large in the corners. To this end, it is possible merely to form an extension in said transverse direction at each of the two opposite longitudinal ends of each of said feed pipes disposed in the longitudinal direction of the tank in the vicinities of the longitudinal side walls of the tank.

Advantageously, said tank is provided with a plurality of said manifolds provided with rows of nozzles disposed one below another in a common vertical plane at different distances from the surface, preferably with one said manifold provided with a row of vertical nozzles disposed in the vicinity of the bottom wall of said tank.

In a preferred variant embodiment, said tank is provided with said movement means for moving liquefied gas by generating an upward gaseous flow curtain, said gaseous curtain preferably extending in a longitudinal direction of said tank, and preferably in an axial position in said tank or against its said vertical side walls, said means for generating gaseous curtains being chosen from among:

a) said fluid injection means for injecting fluid in the liquid state or in the gaseous state and having ejection nozzles, preferably in a vertical direction, said gas preferably comprising gaseous nitrogen; and

b) immersed heating means comprising a pipe through which a heat carrier fluid flows or a Joule-effect heater resistor in the form of a longitudinal element suitable for heating and for re-gasifying said liquefied gas in contact with said heater means, said rectilinear element preferably extending in the longitudinal direction or in the transverse direction of said tank.

It can be understood that nitrogen is advantageous because it is an inert gas that firstly is relatively abundant and inexpensive and secondly has a liquefaction temperature lower than the liquefaction temperatures of liquefied gases of the following types: methane, ethylene, propane, or butane. It can also be understood that injecting inert gas such as nitrogen into said tank is combined with means for removing and re-circulating said inert gas, in particular as described below. While the gaseous curtain is being generated by injecting inert gas, the liquefied gas can also be re-gasified partially on coming into contact with the inert gas, so that a mixture of nitrogen and of said gas corresponding to the liquefied gas but in the gaseous state is removed and caused to re-circulate.

When said means for generating a gaseous curtain include localized heater means suitable for heating said liquefied gas in such a manner as to re-gasify said liquefied gas in contact with said heater means, the gas of said gaseous curtain is the gas corresponding to the gas of the liquefied gas contained in said tank.

Said rectilinear element may rest against or in the vicinity of the bottom wall of said tank or be suspended, immersed in the vicinity of the surface of said liquefied gas.

More particularly, said longitudinal Joule-effect heater element is implemented by means of an electric cable.

In another variant embodiment, said tank is provided with direct liquid movement means consisting of a suction and delivery pump for sucking in said liquefied gas and for delivering it via a horizontal delivery nozzle mounted on said immersed pump, or a motor-driven propulsion propeller immersed in said tank, in such a manner as to move said liquefied gas in a said horizontal direction, and preferably in a direction that is not parallel to said longitudinal axial direction, below the surface of the liquefied gas, said pump or said propeller being mounted on a float in such a manner as to remain immersed permanently at a substantially constant distance from the surface of said liquefied gas contained in said tank, and preferably at a depth of in the range 0.5 m to 5 m, and more preferably said float being mounted to slide vertically on an immersed vertical support.

It can be understood that this vertical support for slidably supporting the float makes it possible to maintain said pump or said propeller in a determined position.

More precisely, said direct movement means acting by propeller motor-driven propulsion or said suction and delivery pumps are disposed in the corners of said tank and are oriented to move said liquefied gas in a horizontal direction towards the central zone of said tank, preferably in each of the four corners of a rectangular horizontal section of said tank.

This embodiment makes it possible to attenuate or indeed to eliminate the strongest sloshing movements and turbulences that tend to build up in the vertical corners of the tank, in particular when the tank is of rectangular horizontal section, if the sloshing inside the tank is not perpendicular to said manifolds and to said side walls of the reservoir because of the combined pitch and roll movements of the ship or floating support.

In a preferred embodiment, said liquid movement means comprise at least:

(a) a manifold provided with a row of fluid ejection nozzles for ejecting fluid in the liquid state or in the gaseous state, preferably for ejecting gaseous nitrogen, and resting on the bottom wall, or a plurality of superposed manifolds provided with respective rows of nozzles in the vicinity of the vertical side walls of the tank, and suitable for forming a gaseous curtain, preferably a curtain of nitrogen or of a mixture of nitrogen and of gas corresponding to the gas of said liquefied gas; and

(b) said direct movement means acting by propeller propulsion or suction and delivery pumps for sucking in and delivering said liquefied gas, disposed in each of the four corners of a said tank that is of rectangular horizontal section, and oriented so as to move the liquefied gas towards the central zone of the tank, i.e. towards the vertical central axis half-way along the tank.

This embodiment is particularly advantageous because it makes it possible to prevent and to attenuate sloshing in the transverse direction perpendicular or inclined relative to said vertical longitudinal side walls of a said large reservoir.

Advantageously, said tank includes, inside it, said gas injection means, said gas preferably comprising gaseous nitrogen, and a gas feed device for feeding gas to said gas injection means, comprising, outside said tank, at least one liquid nitrogen reservoir, a first liquid circulation pump suitable for sending said liquid nitrogen into a first heat exchanger, the heat carrier fluid of which is seawater, said first heat exchanger being suitable for gasifying the liquid nitrogen stored in said reservoir before it is sent back into said horizontal ramps having vertical nozzles, a gas separation unit suitable for separating the removed gaseous mixture that is removed from said tank and comprising gaseous nitrogen and said gas corresponding to said liquefied gas in the gaseous state, and a second circulation pump suitable for compressing said gaseous mixture and for sending it back into said gas injection manifolds.

It can be understood that the gaseous mixture removed from said tank comprises gaseous nitrogen together with said gas corresponding to said liquefied gas in the gaseous state resulting from said liquefied gas being partially heated by the upward stream of gaseous nitrogen.

More particularly, said gas feed device further comprises, at the outlet of said separator, at least one nitrogen liquefaction unit and/or a liquefaction unit for liquefying said gas corresponding to said liquefied gas, which units are suitable for re-liquefying respectively the nitrogen or said gas before sending it respectively into said nitrogen reservoir or into said tank.

Even more particularly, said gas feed device further comprises a liquefaction unit for liquefying said gas corresponding to said liquefied gas and constituted by a second heat exchanger immersed in liquid nitrogen inside said reservoir co-operating with a circulation pump suitable for causing said gaseous nitrogen and said liquefied gas to circulate in pipes respectively feeding said manifolds and said tank.

In another embodiment, said tank is provided, inside it, with injection means for injecting a fluid consisting of a second liquefied gas suitable for evaporating in contact with said first liquefied gas contained in the tank at a temperature greater than the temperature of said second liquefied gas, said second liquefied gas preferably being liquid nitrogen, preferably coming from an outside reservoir of said second liquefied gas, said injection means comprising at least one said manifold provided with a horizontal row of vertical nozzles.

The present invention also provides a method of attenuating movements of liquid in said tank of a ship or floating support, said method being characterized in that a horizontal stream of liquefied gas is established below the surface of said liquid over a depth of at least 0.5 m, and preferably of at least 2 m, by ejecting liquid and/or by establishing a gaseous stream, preferably an upwards gaseous stream of gaseous fluid comprising nitrogen.

More particularly, gaseous nitrogen is injected into said manifolds provided with rows of nozzles.

Advantageously, said manifolds provided with rows of nozzles are fed with gas by a said gas feed device as defined above.

In an implementation, a second liquefied gas, preferably liquid nitrogen, is injected into said manifolds provided with rows of nozzles, said second liquefied gas thus being ejected in the liquid state into said first liquefied gas contained in the tank, said second liquefied gas gasifying and thereby generating an upward gaseous stream inside said first liquefied gas, which first liquefied gas is at a higher temperature than said second liquefied gas.

Since liquid nitrogen at −196° at normal atmospheric pressure is injected into the liquefied gas contained in the tank, e.g. LNG (−176° C. at normal atmospheric pressure) it then finds itself in a liquid at a higher temperature. It thus heats up and evaporates inside said LNG while drawing from the liquefied gas its latent heat of evaporation, thereby cooling said LNG contained in the tank and limiting the evaporation of said LNG contained in the tank.

Other characteristics and advantages of the present invention appear more clearly on reading the following description given by way of non-limiting illustration and with reference to the accompanying drawings, in which:

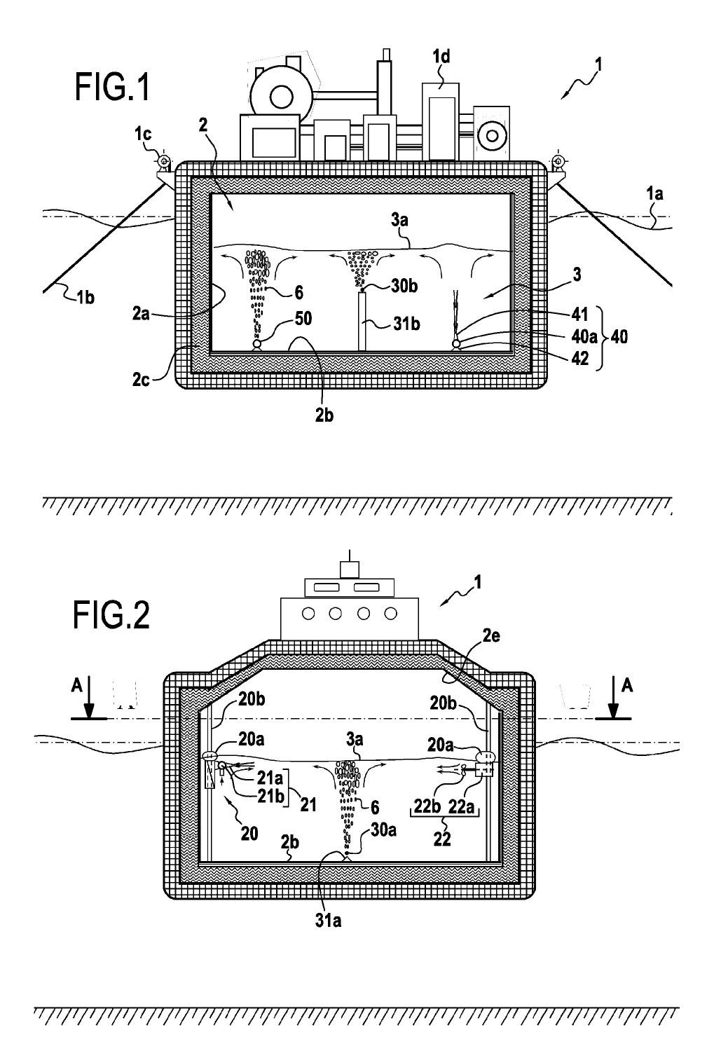

FIG. 1 is an end-on cross-section view of an LNG FPSO unit equipped with sloshing attenuation devices of the invention for attenuating sloshing in its storage tanks, which devices generate a calming fluid constituted by an upward vertical stream of liquid or gaseous fluid that generates surface splitting into horizontal streams of LNG inside a storage tank, and at the surface thereof; and

FIG. 2 is an end-on cross-section view of an LNG carrier ship equipped with sloshing attenuation devices of the invention that generate a horizontal stream of liquid gas inside a storage tank, at the surface thereof; and

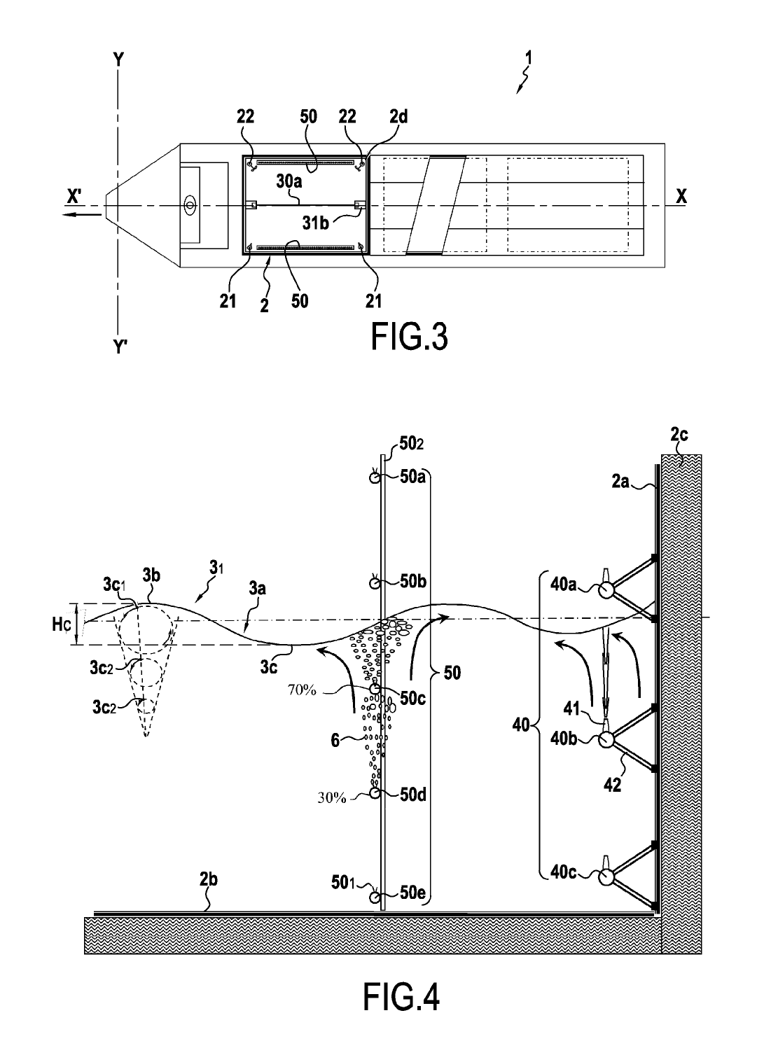

FIG. 3 is a plan view of an LNG carrier ship having three tanks, the first of which tanks, corresponding to the section on plane AA in FIG. 2, is equipped with devices of the invention that generate a horizontal stream of liquid LNG inside a storage tank; and

FIG. 4 is a side-on cross-section view of a tank equipped on its right side with an ejection device 40 for ejecting liquefied gas under pressure, in its centre with ejection devices 50 for ejecting nitrogen-and-methane mixture at five different levels 50a-50e, and that, on its left side, shows the free surface effect and appearance of sloshing; and

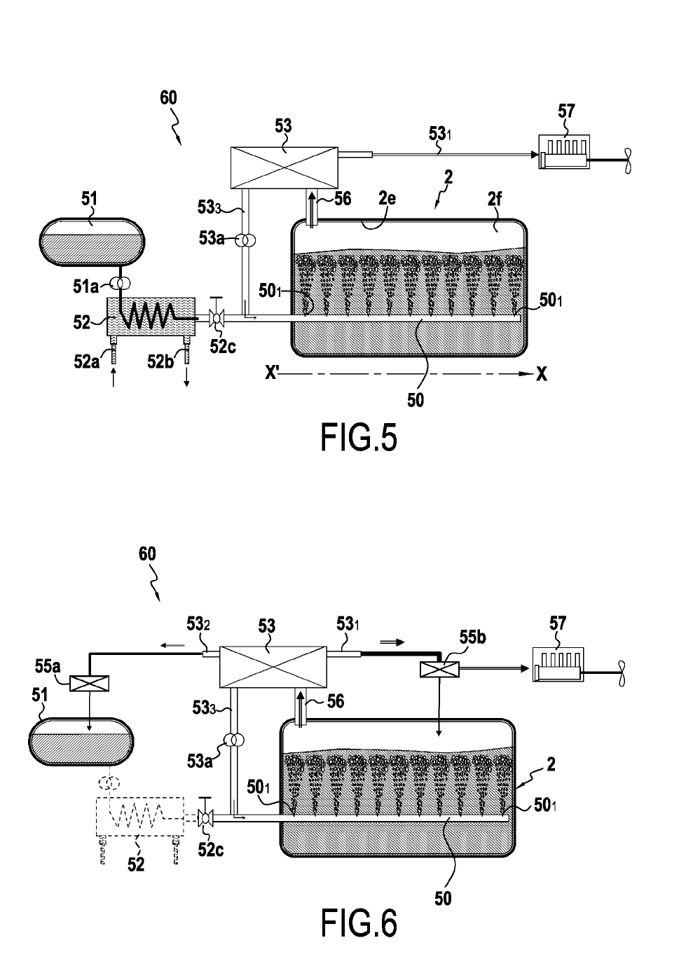

FIG. 5 is a diagram showing the flow cycle of a mixture of gases (N₂+CH₄) between the ullage space of an LNG carrier ship tank and a gas injection manifold or tubular pipe 50 provided with a row of nozzles and situated in the lower portion of said storage tank that is shown in a longitudinal section through the ship with a gas bubble curtain 6 generated by said manifold; and

FIG. 6 is a diagram showing the flow cycle of a mixture of gases (N₂+CH₄) between the ullage space of an LNG carrier ship tank and a gas injection manifold or tubular pipe 50 provided with a row of nozzles and situated in the lower portion of said storage tank, with a view to re-liquefying respectively the nitrogen (N₂) and the methane (CH₄) before the nitrogen (N₂) injection device is stopped; and

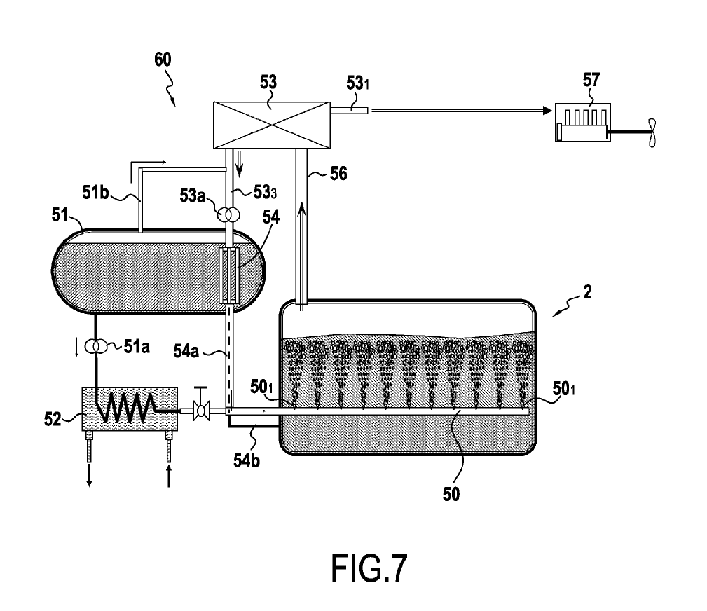

FIG. 7 is a diagram showing the flow cycle of a mixture of gases (N₂ CH₄) between the ullage space of an LNG carrier ship tank and a gas injection tubular pipe 50 situated in the lower portion of said storage tank, the return gas mixture passing through heat exchanger for the purposes of re-liquefying the methane (CH₄).

Various sloshing attenuation devices of the invention for attenuating sloshing in the tank of a ship or of a floating support containing liquid methane are described below, which devices are constituted by means for generating a calming fluid or “movement means” for moving said LNG so as to form a horizontal stream immediately below the surface, which horizontal stream can result from an upward stream splitting, said movement means comprising:

direct movement means 40, 40a-40c and 21 acting by pumping and ejecting the liquefied gas in the liquid state and under pressure into said tank;

direct movement means 22 acting by motor-driven propeller propulsion of said liquefied gas in the liquid state into said tank; and

indirect movement means acting by generating a gas stream in the liquid of said tank, namely gaseous fluid injection means 50, 50a-50e for injecting gaseous fluid into said liquefied gas and comprising a horizontal row of nozzles provided along a gas feed pipe or manifold, or gaseous stream generation means 30a-30b for generating a gaseous stream of gas corresponding to said liquefied gas by heating a resistor 30a by Joule effect or by causing a heat carrier fluid to flow in a pipe 30b and by evaporating said liquid LNG contained in the tank.

In the above-mentioned movement means, a stream of said calming fluid or liquid just below the surface can be generated in the following different manners:

using ejection nozzles mounted on delivery pumps disposed immediately below the free surface, at in the range 0.5 meters (m) to 1 m therebelow, and oriented so that the liquid is ejected directly in the horizontal direction as regards the direct movement means 21 acting by pumping and ejecting said liquefied gas in the liquid state and under pressure into said tank; and

using propellers of horizontal axis as the direct means 22 for motor-driven propeller propulsion of said liquefied gas in liquid form into the tank 21, which propellers are disposed immediately below the free surface, at in the range 0.5 m to 1 m therebelow, and oriented in such a manner that the liquid is ejected directly in the horizontal direction; and

using ejection nozzles provided in the form of rows formed by respective horizontal manifolds or feed pipes, and disposed at distances further away from the surface, in particular at least in the range 3 rows to 5 rows that are superposed in the vicinity of a longitudinal side wall of the tank, but that are oriented vertically so that the liquid or gaseous fluid is directed upwards towards the surface, as it is with the gaseous fluid injection means 50, 50a-50e for injecting gaseous fluid into said liquefied gas and with the direct movement means 40, 40a-40c and 21 acting by pumping and ejecting said liquefied gas in the liquid state and under pressure into said tank.

FIG. 1 is a cross-section view through a ship 1 of the FPSO unit type anchored by lines 1b connected to winches 1c, which FPSO unit is installed over a petroleum field and receives gas from undersea well heads via pipes (not shown), said gas being treated on board in installations 1d so as to be cooled to a temperature less than −163° C. and so as to be stored in tanks 2 before being offloaded to methane carrier ships that then carry said gas, still in liquid form, to users. Said tank 2 is equipped with devices of the invention that serve to prevent the appearance of undesired sloshing movements due to the free surface effect and generated inside the tank by the confined liquid contents resonating with external swell 1a to which the ship is subjected and which is generated by wind or by sea currents. Such sloshing is explained below in more detail in the description of the invention. Each of the rectangular block shaped tanks has a volume of 24,000 with a width of 20 m, a length of 40 m and a height of 30 m, it being possible for the largest of such tanks to be as large as or even larger than 60,000 m².

FIG. 2 is a cross-section view through a ship 1 of the methane carrier type equipped with other devices of the invention. FIG. 3 is a plan view of an LNG carrier ship having three tanks, the left first one of which, corresponding to the section on plane AA of FIG. 2, is equipped with devices of the invention that generate a horizontal stream of liquefied gas inside a storage tank, in the vicinity of the free surface 3a.

The left portion of FIG. 4 shows in detail undesired sloshing phenomenon whereby a regular swell 3 forms and propagates inside the tank 2. When such sloshing forms inside said tank, the particles of liquefied gas substantially describe a circle, the greater agitation at the surface continues towards the bottom before dying out. Thus, close to the surface 3a, a particular of liquefied gas 3c1 describes a circle having a top tangent corresponding to the crest 3b of the wave 3-1 and a bottom tangent corresponding to the trough 3c of said wave. In the same way, a particle 3c2 at an intermediate depth and a particle 3c3 at a greater depth are moved, synchronously to the particle 3c1, over respective circles, the circle of the particle 3c2 being of medium diameter and the circle of the particle 3c3 being of small diameter.

The swell shown in FIG. 4 is simple swell as can be observed out at sea, but when such swell is confined inside a tank 2 it rebounds off the side walls 2a and then finds itself reflected while keeping its own energy, i.e. its period and its amplitude. This then results in surface agitation or chop that is of greater or lesser magnitude depending on the sea conditions. The waves thus reflected off the walls combine together and can develop towards decreasing states of agitation when the recombination takes place out of phase, or towards increasing states of agitation when the waves are in phase.

Thus, when the ship 1 is subjected to external swell 1a, either coming from out at sea or due to wind or to current, the roll, pitch, yaw, sway, and surge movements of the ship excite the liquid contained in the tank 2 and resonance phenomena can then occur inside said tank because of the above-described combinations of the multiple reflections off the walls of the tanks.

Such sloshing may be violent and lead to a risk of damage being done to the retention and confinement systems for retaining and confining the liquefied gas. Such sloshing does not take place only in the event of storms. It can appear even in calm weather when certain parameters related to the behavior of the ship, to the shape of its tanks and to the level of filling of said tanks are present at the same time. For example, a beam sea of small amplitude, e.g. of significant height Hs=1.25 m, related to particular periods, e.g. T=8 seconds to 10 seconds, does not present any danger when the tanks are full or are empty, or indeed are at intermediate filling levels, but for a specific value, e.g. in the range 70% filling to 80% filling, resonance phenomena appear under such specific conditions leading to dangerous behavior of the liquid gas cargo that can give rise to very violent sloshing against the walls of the tanks. Such violent sloshing can then give rise to the confinement or insulation system being damaged or even ruined, thereby putting the ship and its entire crew in great danger.

Tests conducted on dynamic models by the Applicant have shown that the formation of sloshing-type agitation inside a ship's tank for storing liquefied gas is disturbed by a horizontal stream generated in a zone close to the surface of said liquefied gas, as shown in FIG. 4, such a stream being generated, for example, by a device 40 generating a jet exiting from a nozzle 41 fed with liquid (liquefied methane) under pressure via a horizontal manifold or pipe 40a that is fed by a pump (outside the tank and not shown) with liquid coming from the tank, and that is fastened to the wall 2a via a support structure 42. Said jet is then advantageously directed upwards and, once the particles reach the surface, the jet changes direction naturally so as to form a horizontal jet. The combination of the vertical and horizontal jets locally disturbs the orbital movements of the particles, as explained above, and thus disturbs swell formation inside the tank, and thus disturbs the undesired resonance phenomena. Although very powerful jets are required in order to calm a swell that is already formed, in order to prevent swell from amplifying and from reaching resonance conditions, the required power is much lower, and can be of a smaller order of magnitude. In FIG. 4, three devices 40a-40c have advantageously been disposed at different heights, e.g. for a tank having a height of 20 m, at 2 m, 7 m, and 12 m from the bottom wall 2b, against said side wall 2a in such a manner as to actuate only one device under optimal conditions. When the filling level is intermediate, as shown in FIG. 4, only the intermediate device 40b that is situated close to the surface is fed, the other devices 40a and 40c being deactivated. If the level in the tank is high, then only the top manifold for feeding the device 40a is fed, whereas if the level is low, only the manifold of the bottom device 40c is fed.

FIG. 2 shows a device 21 of the invention that is constituted by a float 20a that is freely slidably guided along a post 20b extending vertically between the bottom 2b and the ceiling 2e of the tank. Said float supports an immersed pump 21a immersed at 1 m below the free surface, powered via an electric cable (not shown), and sucking the LNG directly from the tank and delivering it via a horizontal nozzle 21b so as to generate a disturbing transverse horizontal stream, in the vicinity of the surface 3a of the liquefied gas. In FIG. 2, a heater electric cable 30a is disposed close to the bottom 2b of said tank, substantially parallel to the axis of the ship, and designed to evaporate the liquefied gas by the Joule effect. The localized heating thus generates bubbles that then rise to the surface, thereby generating a vertical upward stream that, at the surface 3a of said liquefied gas splits into two horizontal streams of opposite directions, one flowing to port and the other to starboard. In the right of FIG. 2, a device 22 has been installed that is also immersed at 1 m below the free surface and that is a variant of the above device, the variant device being constituted by a float 20a freely slidably guided along a post 20b extending vertically between the bottom 2b and the ceiling 2e of the tank. Said float supports an electric motor 22a powered by an electric cable (not shown) and actuating a propeller 22b of horizontal axis so as to generate a disturbing transverse horizontal stream in the vicinity of the surface 2d of the liquefied gas.

FIG. 1 shows three other variant devices of the invention that are installed inside the tank 2, respectively a device 50 comprising a horizontal manifold provided with a plurality of ejection orifices spaced apart by in the range 0.5 m to 3 m, which manifold is designed to inject gas from the bottom of said tank that forms an upward stream of a gas curtain 6 extending in the longitudinal direction of the tank as shown in FIGS. 5 to 7. The bubbles formed rise to the surface and generate an upward stream that, close to the surface, splits into two opposite streams, one flowing to starboard, and the other to port. A second device is constituted by a heater element 30a, e.g. an electric cable, or indeed a pipe 30b through which heat carrier fluid flows, supported at 31a at the bottom of the tank as shown in FIG. 2, and suspended at the tops of two vertical supports 31b as shown in detail in FIG. 3. Said heater element re-gasifies the LNG, thereby generating bubbles that then rise towards the surface, thereby generating a calming fluid constituted by a vertical upward stream in the form of a gas curtain 6 that, at the surface 3a of said liquefied gas, splits into two horizontal streams of opposite directions, one flowing to port and the other to starboard. Finally, on the right, a device 40 installed at the bottom of the tank, and constituted by a nozzle 41 fed via a manifold 40a fed with LNG by a pump (not shown), generates a calming fluid constituted by an upward movement of the liquid that splits to port and to starboard once it reaches the free surface 3a of the liquid.

FIG. 3 is a plan view of a methane carrier ship equipped with three tanks, the tank at the forward end of the ship being equipped with two rows of horizontal nozzles 50 fed with gas under pressure, with two floating pumps 21 equipped with nozzles and situated in the corners 2d of the tank on the port side, two floating propellers 22 as described with reference to FIG. 2, in the corners 2d of the tank on the starboard side, and a central pipe 30b through which a heat carrier fluid flows and that serves to re-gasify the liquefied gas so as to form a central gas curtain. In FIGS. 1 and 3, the pipe 30b and the cable 30a are suspended at in the range 2 m to 5 m from the bottom of the tank. Advantageously, a plurality of pipes 30b or cables 30a are installed permanently at various heights of the tank, e.g. every 3 m.

In a version shown in detail in FIG. 5, a bubble curtain is generated by injecting nitrogen into a manifold equipped with a row of nozzles and situated either at the bottom of the tank, or at a variable height. To this end, the nitrogen is stored in the liquid state in a reservoir 51 and is sent into a heat exchanger 52 by means of a metering pump 51a. Inside said heat exchanger 52, the liquid nitrogen (−196° C.) is transformed into gas by means of the heat brought, for example, by high-temperature steam arriving hot at 52a and exiting in the form of condensed cold water at 52b, and then joins the manifold 50 provided with a plurality of nozzles 50-1. The gaseous nitrogen then rises towards the surface while generating an upward vertical stream, and thus a calming fluid, inside the liquid methane or LNG (−165° C.) and mixes with the ullage gas 2f, which is then constituted by a mixture of methane and of nitrogen. The mixture is then recovered at the ceiling 2e of the tank and is sent 56 into a separator 53, e.g. of the molecular sieve type, in which a fraction of the methane is separated out and sent via 53₁ to participate, e.g. as a fuel, in the engine for propelling the ship 57. The remaining mixture is then re-directed via 53₃ towards the manifold 50 via a circulation compressor 53a that thus causes the mixture that serves to generate the bubble curtain to circulate, generating the upward stream of calming fluid inside the LNG.

Thus, on starting up the device, the isolation valve 52c is opened, then the heat exchanger 52 is fed with heat carrier fluid (steam), then the metering pump 51a is actuated in a manner such as to re-gasify the liquid nitrogen, and then simultaneously the circulation pump 53a is actuated, thereby generating the desired bubble curtain inside the LNG. When the circulation state is stabilized and enough nitrogen has been injected into the device, the injection pump 51a is stopped and the valve 52c is closed. The nitrogen contained in the loop constituted by the ullage space 2f of the tank, by the separator 53, and by the connection pipes, remains constant insofar as the separator 53 presents sufficient effectiveness and sends only methane as fuel towards the main engine 57, which is either of the steam turbine type or of the piston engine type.

In reality, a fraction of the gaseous nitrogen is dissolved in the LNG, and the nitrogen concentration of the ullage space 2f is monitored continuously, and the nitrogen is topped up by re-gasifying liquid nitrogen as explained above.

In the event that separation is not perfect, the gas sent as fuel then contains nitrogen in addition to methane, which is not problematic for operation of said main engine 57. However, the nitrogen concentration is monitored and advantageously topped up continuously as explained above.

FIG. 6 shows the device of FIG. 5 as equipped with a nitrogen re-liquefaction first unit 55a and with a methane re-liquefaction second unit 55b, which units are useful during the stage of stopping the bubble curtain. If the bubble curtain is to be stopped, the gas mixture continues to be caused to circulate, but since the separator is provided with a nitrogen outlet 53₁ and with a methane outlet 53₂, the nitrogen is advantageously re-liquefied in the unit 55a before it is sent back into the reservoir 51b, and, similarly, all of or a fraction of the methane is re-liquefied in the unit 55b before it is sent back into the liquid methane storage tank, the remainder advantageously being directed towards the main engine 57 to be used as fuel therein.

The looped circulation of the mixture of nitrogen and of methane generates a large contribution of energy, due to the circulation compressor 53a, and, as a result, a significant fraction of liquid methane is re-gasified and needs to be removed because the ullage space of the tanks should remain substantially at ambient atmospheric pressure, the structure of the tanks and of the ship not being designed to withstand significant increases in pressure inside the tanks. It is thus necessary either to remove the gaseous methane, e.g. by using it as fuel for the main engine, as explained above with reference to FIG. 5, and/or to re-liquefy it as explained above with reference to FIG. 5. It should be noted that since nitrogen has a liquefaction temperature substantially equal to −196° C. at atmospheric pressure, it is never in liquid phase in methane liquefied at a temperature substantially equal to −163° C.

FIG. 7 shows a preferred version of the invention as shown in FIG. 5, in which version the gaseous mixture of nitrogen and of methane exits from the separator 53, and then passes through the compressor 53a and passes through a heat exchanger 54 in contact with the liquid nitrogen at −196° C. At this temperature, the methane re-liquefies as LNG, and a mixture of gaseous nitrogen and of gaseous methane and of LNG then flows down inside the outlet pipe 54a and reaches the manifold 50, and the gaseous nitrogen, possibly with traces of gaseous methane, is directed towards the injection manifold 50, while the liquid methane, or LNG, is removed at the lower portion of said pipe 54a, via a pipe 54b towards the lower portion of the tank 2. The hydrostatic pressure generated by the compressor 53a is such that the liquid methane contained in the tank cannot flow back up inside the pipe 54b, or reach the gas injection manifold 50. The liquefaction of the methane into LNG inside the heat exchanger 54 absorbs heat energy and thus causes the liquid nitrogen to boil in the reservoir 51; the gaseous nitrogen produced is advantageously directed via a pipe 50a towards the pipe 53₃, preferably immediately upstream of the compressor 53a. Said gaseous nitrogen produced may advantageously be re-liquefied in a unit of the same type as 55a and not shown, and the liquid nitrogen produced is then merely redirected towards said reservoir 51.

In the description of the bubble curtains with reference to FIGS. 5, 6, and 7, the injection manifold 50 is situated in the lower portion of the tank 2.

However, a plurality of said manifolds 50a-50e are advantageously installed at various heights, e.g. 0 m, 5 m, 10 m, 15 m for a tank having a height of 20 m, either close to the side walls of the tanks or towards the axis of the ship, as shown in FIG. 4. The manifolds are thus installed at a plurality of levels and are secured to a vertical support 50₂ connecting the floor 2b of said tank to the ceiling thereof. They pass through the tank 2 from one end to the other, e.g. parallel to the axis of the ship, and they are fed from one end at the vertical walls with an N₂+CH₄ gaseous mixture under pressure. Thus, it is possible either for one of the manifolds that is situated below the surface 3a of the liquefied gas to be fed, or, advantageously, for a plurality of manifolds 50c and 50d situated at different depths under the surface 3a of said liquefied gas to be fed. With the gas injection being, for example, split into two flows at different hydrostatic pressures, the first flow, representing, for example, 70% by volume, is ejected at the manifold 50c that is closest to the surface 3a, the remaining 30% is ejected lower down at 50d at a higher hydrostatic pressure, at the manifold 50d beneath 50c. In this way, the upward stream that is generated is advantageously optimized and thus the performance and effectiveness of the calming fluid are thus advantageously optimized, as a function of the filling level of the tank and of the positions of said injection manifolds relative to the walls of the tank.

The vertical corners 2d of the tanks are zones where, in the event of sloshing, large impacts might occur because of the trihedral shape formed by the two vertical walls and by the ceiling of the tank. In these zones, it is advantageous, as shown in FIG. 3, to combine injections of gas mixtures and injections of liquid methane flows generated by nozzles associated with manifolds 40a-40c as shown in FIG. 4. In these sensitive zones, the combination of the two flows makes it possible to generate very large movements of fluid, and, due to the presence of gas bubbles, said fluid is of very high compressibility, which makes it possible to attenuate strongly the effects of any impacts that occur, most of the sloshing energy being absorbed by the compressibility of said bubbles that are generated in this way. Since any such sloshing energy is transformed into heat, local evaporation of the liquid methane causes a corresponding increase in the quantity of gaseous methane circulating in looped manner in the device.

In the embodiment shown in FIG. 3, a plurality of superposed manifolds 50a-50d are advantageously implemented as described with reference to FIG. 4.

In the embodiment shown in FIG. 3, firstly transverse horizontal streams are established over the entire length of the tank by means of said manifolds 50, disposed in the vicinities of the vertical longitudinal side walls, and secondly localized horizontal streams are established in the corners of the tank only, disposed angularly non-parallel to the longitudinal direction of the tank towards a vertical central axis half-way along the longitudinal direction of the tank, i.e. along a diagonal of a tank of rectangular longitudinal horizontal section.

FIGS. 5 to 7 show a continuous gas curtain over the entire length of the tank. However, it is possible to provide a plurality of gas curtains spaced apart from one another in the longitudinal direction of the tank, by varying the space between the nozzles 50₁ of the manifold 50.

In the description of the invention, the devices are described mainly as being installed on the walls of the tanks that are parallel to the axis of the ship. However, in addition, devices are advantageously disposed on the walls of said tanks transversely, i.e. perpendicularly to the longitudinal axis XX of the ship, these devices being more particularly effective in the event of resonance phenomena due to the ship pitching or surging.

In a preferred version of the invention, instead of the nozzles injecting gaseous nitrogen or a mixture of nitrogen and of methane, they inject directly liquid nitrogen at −196° C. (at normal atmospheric pressure) that is stored in specific accessory reservoirs. Thus, the gas arrives in the liquid state in the diffusion manifolds and is ejected in the liquid state into the LNG. Since the LNG is at a higher temperature (−165° C. at normal atmospheric pressure), it then heats the liquid nitrogen that evaporates while transferring to the LNG its latent heat of evaporation. Thus, in this preferred version, since the nitrogen is transferred inside the pipes in the liquid state, it requires pipes of smaller diameter than the pipes necessary for conveying nitrogen in gaseous form. In addition, this transfer of latent heat from the evaporating nitrogen cools the LNG and limits the evaporation of said LNG correspondingly, thereby facilitating management of the gaseous methane that it would have been necessary either to re-liquefy or to direct to the main engine for use as fuel. Thus, liquid nitrogen is advantageously and continuously fabricated from the ambient air, by separation from oxygen and from the various rare gases, and then the liquid nitrogen is stored in dedicated reservoirs, and liquid nitrogen is tapped whenever necessary and sent into the distribution manifold circuit, towards the tanks concerned by the risks of undesired sloshing.

In the present invention, the LNG tanks are described as being cylindrical and of polygonal section. However, such tanks remain within the spirit of the invention whenever the cross-section includes a polygonal portion and a curved portion, as described, for example, in Patent WO-2001-30648, it being understood that said curved portion can be likened mathematically and geometrically to a polygon of finite developed length, having an infinity of sides of unit lengths that are infinitely small.

1-20. (canceled)

21. A ship or floating support for carrying or storing liquid inside a reservoir and including a large tank, said liquid consisting of a liquefied gas, preferably chosen from methane, ethylene, propane, and butane, cooled in said large tank, said large tank having its length disposed in the longitudinal direction of the ship and being preferably cylindrical and of cross-section that is at least in part polygonal and of axis in the longitudinal direction of the ship, said large tank being thermally insulated and of large size with at least its smallest dimension in the horizontal direction, in particular its width, being greater than 20 m and preferably in the range 25 m to 50 m, and presenting a volume greater than 10,000 m³, wherein said reservoir is equipped with at least one attenuation device for attenuating movements of said liquid and comprising movement means for moving said liquefied gas liquid inside said reservoir so as to form a horizontal stream immediately below the free surface of said liquefied gas at least locally over a depth of at least 0.5 m, and preferably at least 2 m.

22. The ship or floating support according to claim 21, wherein said movement means for moving said liquefied gas liquid inside said reservoir generate a movement of said liquefied gas in a direction that is not parallel to said longitudinal axial direction of the tank, and preferably in a transverse direction that is perpendicular to said longitudinal axial direction of the tank.

23. The ship or floating support for carrying or storing liquid according to claim 21, wherein said movement means for moving said liquid are fluid ejection means for ejecting fluid, said fluid in liquid or in gaseous form being chosen from a liquid fluid consisting of said liquefied gas, and preferably LNG, or a gaseous fluid comprising an inert gas and preferably nitrogen, or a gas corresponding to the gas of said liquefied gas contained in said tank but in the gaseous state, or a mixture of said inert gas and of said gas in the gaseous state corresponding to the gas of said liquefied gas.

24. The ship or floating support for carrying or storing liquid according to claim 21, wherein a vertical gaseous stream is generated inside said tank below the free surface of said liquefied gas, and preferably from the bottom of the tank and in the vicinities of the side walls of the tank.

25. The ship or floating support for carrying or storing liquid according to claim 21, wherein said ejection means for ejecting liquid or gaseous fluid comprise at least one pump outside said tank, and at least one manifold provided with a row of nozzles and consisting of a fluid feed pipe for feeding said fluid and disposed horizontally beneath the surface of the liquid inside said tank, and preferably at least one said feed pipe disposed in the vicinity of the bottom wall, said fluid feed pipe being provided with a plurality of ejection nozzles for ejecting said fluid upwards towards the surface in the vertical direction, the various successive nozzles of the same feed pipe preferably being spaced apart from one another by at least 0.5 m, and more preferably by in the range 1 m to 5 m.

26. The ship or floating support for carrying or storing liquid according to claim 25, wherein said fluid feed pipe(s) is/are disposed in the transverse direction or preferably in the longitudinal direction of said tank, and preferably in the vicinity of each of the two opposite side walls of the tank.

27. The ship or floating support for carrying or storing liquid according to claim 26, wherein said tank is provided with a plurality of said manifolds provided with rows of nozzles disposed one below another in a common vertical plane at different distances from the surface, preferably with one said manifold provided with a row of vertical nozzles disposed in the vicinity of the bottom wall of said tank.

28. A ship or floating support for carrying or storing liquid according to claim 21, wherein said tank is provided with said movement means for moving liquefied gas by generating an upward gaseous flow curtain, said gaseous curtain preferably extending in a longitudinal direction of said tank, and preferably in an axial position in said tank or against its said vertical side walls, said means for generating gaseous curtains being chosen from among:
a) said fluid injection means for injecting fluid in the liquid state or in the gaseous state and having ejection nozzles, preferably in a vertical direction, said gas preferably comprising gaseous nitrogen; and
b) immersed heating means comprising a pipe through which a heat carrier fluid flows or a Joule-effect heater resistor in the form of a longitudinal element suitable for heating and for re-gasifying said liquefied gas in contact with said heater means, said rectilinear element preferably extending in the longitudinal direction or in the transverse direction of said tank.

29. The ship or floating support according to claim 28, wherein said longitudinal Joule-effect heater element is an electric cable.

30. The ship or floating support for carrying or storing liquid according to claim 21, wherein said tank is provided with direct liquid movement means consisting of a suction and delivery pump for sucking in said liquefied gas and for delivering it via a horizontal delivery nozzle mounted on said immersed pump, or a motor-driven propulsion propeller immersed in said tank, in such a manner as to move said liquefied gas in a said horizontal direction, and preferably in a direction that is not parallel to said longitudinal axial direction, below the surface of the liquefied gas, said pump or said propeller being mounted on a float in such a manner as to remain immersed permanently at a substantially constant distance from the surface of said liquefied gas contained in said tank, and preferably at a depth of in the range 0.5 m to 5 m, and more preferably said float being mounted to slide vertically on an immersed vertical support.

31. The ship or floating support according to claim 30, wherein said direct movement means acting by propeller motor-driven propulsion or said suction and delivery pumps are disposed in the corners of said tank and are oriented to move said liquefied gas in a horizontal direction towards the central zone of said tank, preferably in each of the four corners of a rectangular horizontal section of said tank.

32. The ship or floating support for carrying or storing liquid according to claim 25, wherein said liquid movement means comprise at least:
(a) a manifold provided with a row of fluid ejection nozzles for ejecting fluid in the liquid state or in the gaseous state, preferably for ejecting liquid or gaseous nitrogen, and resting on the bottom wall, or a plurality of superposed manifolds provided with respective rows of nozzles in the vicinity of the vertical side walls of the tank, and suitable for forming a gaseous curtain, preferably a curtain of nitrogen or of a mixture of nitrogen and of gas corresponding to the gas of said liquefied gas; and
(b) said direct movement means acting by propeller propulsion or suction and delivery pumps for sucking in and delivering said liquefied gas, disposed in each of the four corners of a said tank that is of rectangular horizontal section, and oriented so as to move the liquefied gas towards the central zone of the tank, i.e. towards the vertical central axis half-way along the tank, along its middle longitudinal axis.

33. The ship or floating support for carrying or storing liquid according to claim 31, wherein said tank includes, inside it, said gas injection means, said gas preferably comprising gaseous nitrogen, and a gas feed device for feeding gas to said gas injection means, comprising, outside said tank, at least one liquid nitrogen reservoir, a first liquid circulation pump suitable for sending said liquid nitrogen into a first heat exchanger, the heat carrier fluid of which is seawater, said first heat exchanger being suitable for gasifying the liquid nitrogen stored in said reservoir before it is sent back into said horizontal ramps having vertical nozzles, a gas separation unit suitable for separating the remove gaseous mixture that is removed from said tank and comprising gaseous nitrogen and said gas corresponding to said liquefied gas in the gaseous state, and a second circulation pump suitable for compressing said gaseous mixture and for sending it back into said gas injection manifolds.

34. The ship or floating support for carrying or storing liquid according to claim 33, wherein said gas feed device further comprises, at the outlet of said separator, at least one nitrogen liquefaction unit and/or a liquefaction unit for liquefying said gas corresponding to said liquefied gas, which units are suitable for re-liquefying respectively the nitrogen or said gas before sending it respectively into said nitrogen reservoir or into said tank.

35. The ship or floating support for carrying or storing liquid according to claim 34, wherein said gas feed device further comprises a liquefaction unit for liquefying said gas corresponding to said liquefied gas and constituted by a second heat exchanger immersed in liquid nitrogen inside said reservoir co-operating with a circulation pump suitable for causing said gaseous nitrogen and said liquefied gas to circulate in pipes respectively feeding said manifolds and said tank.

36. The ship or floating support according to claim 32, wherein said tank is provided, inside it, with injection means for injecting a fluid consisting of a second liquefied gas suitable for evaporating in contact with said first liquefied gas contained in the tank at a temperature greater than the temperature of said second liquefied gas, said second liquefied gas preferably being liquid nitrogen, preferably coming from an outside reservoir of said second liquefied gas, said injection means comprising at least one said manifold provided with a horizontal row of vertical nozzles.

37. A method of attenuating movements of liquid in a tank of a ship or floating support, said tank having its length disposed in the longitudinal direction of the ship and being preferably cylindrical and of cross-section that is at least in part polygonal and of axis in the longitudinal direction of the ship, said large tank being thermally insulated and of large size with at least its smallest dimension in the horizontal direction, in particular its width, being greater than 20 m and preferably in the range 25 m to 50 m, and presenting a volume greater than 10,000 m³, wherein a horizontal stream of liquefied gas is established below the surface of said liquid over a depth of at least 0.5 m, and preferably of at least 2 m, by ejecting liquid and/or by establishing a gaseous stream, preferably an upwards gaseous stream of gaseous fluid comprising nitrogen.

38. The method according to claim 37, wherein gaseous nitrogen is injected into manifolds provided with rows of nozzles.

39. The method according to claim 38, wherein said manifolds provided with rows of nozzles are fed with gas by a said gas feed device.

40. The method according to claim 37, wherein a second liquefied gas, preferably liquid nitrogen, is injected into said manifolds provided with rows of nozzles, said second liquefied gas thus being ejected in the liquid state into said first liquefied gas contained in the tank, said second liquefied gas gasifying and thereby generating an upward gaseous stream inside said first liquefied gas, which first liquefied gas is at a higher temperature than said second liquefied gas.
